(19) United States
(12) Patent Application Publication
(10) Pub. No.: US 2007/0023055 A1
(43) Pub. Date: Feb. 1, 2007

(54) Dental appliance to prevent the negative effects of bruxism

(76) Inventor: Steven E. Roth, (US)

Correspondence Address: CAROL N. GREEN, ESQ.;LAW OFFICE OF CAROL N. GREEN, P.A., WACHOVIA FINANCIAL CENTER, 200 S. BISCAYNE BLVD., SUITE 2680, MIAMI, FL, 33131, US

(21) Appl. No.: 11/192,675

(22) Filed: Jul. 30, 2005

(51) Int. Cl. A61C 5/14

(52) U.S. Cl. 128/861

(57) ABSTRACT

The present invention relates generally to dental appliances, and more specifically, to a unique bite guard that protects the teeth from the negative effects of teeth grinding or clenching, or other temporomandibular disorders which may include tension headaches, teeth fracture, cracking and/or loss. The application and configuration of the dental appliance is aesthetically superior to other configurations and arrangements and comprises of an outer shell that is small in configuration and is sized to fit the lower portion of a patient's lower front teeth. The dental appliance further includes an inner pliable layer that is in mating engagement with the inner anterior wall and the inner posterior wall of the outer shell. The inner pliable layer is also in mating engagement with the patient's front incisors and conforms to the patient's dentition.

### FIELD OF THE INVENTION

The present invention relates generally to dental appliances, and more specifically, to a unique bite guard that protects the teeth from the negative effects of teeth grinding or clenching, or other temporomandibular disorders which may include migraine and/or tension headaches, tooth fractures, cracked fillings which can result in the need for more extreme dental work from crowns to root canals and may even necessitate extraction.

### BACKGROUND OF THE INVENTION

For various reasons certain individuals engage in an uncontrolled forcible grinding and clenching of their teeth a/k/a bruxism during their sleep. Bruxism affects up to 80% of the population at one point or another in their lives. Unfortunately bruxism can cause damage to the tooth enamel leading to fracturing and eventual loss of teeth. This occurs because of the excessive force exerted on the tooth surfaces which may reach up to ten times greater than the pressure exerted during waking hours producing fractures and erosion of the tooth surfaces. Gum recession, tooth mobility and shifting, cosmetic damage, sore facial muscles, headaches, migraines, ear-aches and sensitive teeth are also common symptoms among patients who suffer from bruxism.

There are several devices that presently exist in the prior art to treat teeth grinding or clenching, or other related physiological, temporomandibular conditions as seen from the references: U.S. Pat. Nos. 6,666,212, 6,581,603, 5,816,802, 5,795,150, 5,533,524, 5,513,656, 5,406,962, 5,277,203, 3,478,429, 3,286,576, and 1,302,004. Many of these dental devices have various limitations and are cumbersome. Generally, these dental devices are either custom-made or boil and bite type transparent horseshoe shaped appliances made of hard or soft plastic that mainly just protect the teeth and do nothing to reduce or eliminate the bruxism and clenching problem.

In some instances, the dental devices of the prior art require a substantially large contact surface, which may be configured and sized as a necessary protrusion to prevent contact between the upper and lower teeth. See U.S. Pat. Nos. 6,666,212, 6,581,603, 5,816,802, and 5,795,150. However, many of these devices are not necessarily as comfortable as it was intended and is not easily manufactured. Thus, there is a need in the art for a comfortable and seamless fit with a patient's dentition that accommodates the proper tongue and tooth placement, easily manufactured, yet effective to accomplish the purposes of this invention.

Similarly, there still exists a need in the art for a simplified dental device that can conform to multiple and varied dentition and settings, yet easy enough for a patient to fit and use at home while still accomplishing the purposes of the invention. Several of the dental devices disclosed in the prior art also require custom molding by a dentist of the patient's dentition. The molding process can be costly and extensive requiring several fittings before the desired fit is achieved. Thus, there is a need in the art for a dental device that can be used by the patient to accomplish the purposes of this invention without having to wait on a dentist's availability to adjust, modify and retrofit the dental device.

There is also a need in the art for a simplified, custom-fitted, comparatively inexpensive dental device that a patient can fit and use at home that negates the harmful effects of bruxism that is easily manufactured while retaining its effectiveness.

The present invention satisfies these longstanding needs.

### SUMMARY OF THE INVENTION

The present invention provides a dental appliance in the form of a unique bite guard that is resilient, supportive and can be custom fitted to accommodate the patient's dentition while maintaining the necessary stability to be secured in the patient's mouth to protect the teeth from the negative and harmful effects of bruxism.

Another object of the invention is to prevent the upper and lower teeth from contacting thereby protecting them from damage in a simple, effective and convenient manner.

Another object of the invention is to provide a bite guard that has hard interior inclines which separate the posterior teeth when the patient closes on the anterior teeth thus preventing bruxism.

Another object of the invention is to prevent the upper and lower teeth from contacting without the necessity of an extensive configuration or protrusion heretofore necessary to prevent the upper and lower dentition from making contact.

Another object of the invention is to provide a dental appliance that allows for the proper positioning of the teeth and tongue so as to reduce bruxism.

Another object of the invention is to provide a comparatively inexpensive dental appliance easily fitted to a patient's dentition by a patient without a dentist's preparation, fitting and adjustments heretofore necessary in the production of custom molded dental appliances that seek to address the problems associated with bruxism.

Another object of the invention is to provide a dental appliance in the form of a unique bite guard which conforms to the lower portion of a patient's upper incisors and affords the necessary stability to remain in place once inserted, and which can easily be replaced or readapted to fit every few months or as needed.

Another object of the invention is to provide a dental appliance in the form of a unique bite guard, which is easy to use, small in size, suitable for children as well as adults and comfortable to wear promoting good patient compliance.

### BRIEF DESCRIPTION OF THE DRAWINGS

Further objectives and advantages of the invention will become more apparent from the following description and claims and from the accompanying drawings herein.

FIG. 1 is a frontal view of the dental appliance in mating engagement with the patient's upper front teeth.

FIG. 2 is rear view of the dental appliance.

FIG. 3 is a side view of the dental appliance.

FIG. 4 is side view of the dental appliance.

FIG. 5 is a frontal view of an alternate embodiment of the dental appliance.

### DETAILED DESCRIPTION OF THE PREFERRED EMBODIMENTS

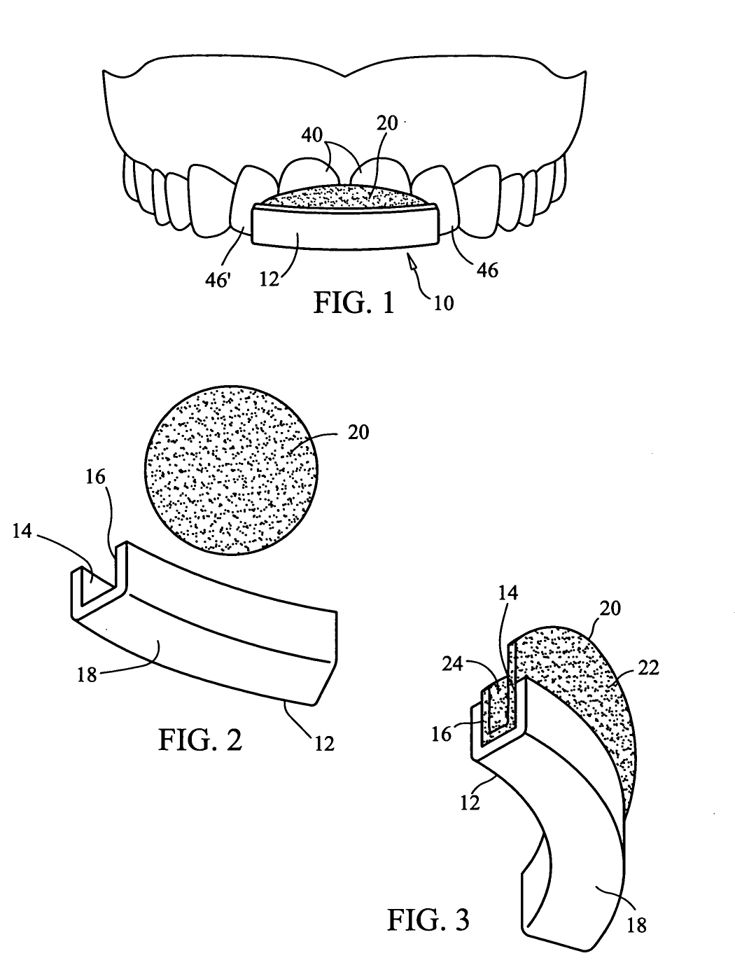

By reference to the exemplary drawings in detail wherein like numerals indicate like elements throughout the various views, there is shown in FIG. 1 the unique bite guard in accordance with the invention.

FIG. 1 shows a frontal view of the present invention, which provides for a dental appliance in the form of a unique bite guard 10 over the patient's upper front teeth 40, 46, 46′. The bite guard 10 functions to reduce the negative effects of bruxism or even eliminate the bruxism habit. The bite guard 10 includes an outer shell 12 that takes the form of a generally arcuate mouth-piece like device having a radius of a curvature smaller than the patient's full dentition. In accordance with this invention, the outer shell 12 is formed from a resilient, firm, non-toxic material such as a prefabricated polycarbonate matrix shell. In other embodiments, other resilient, firm, non-toxic materials can be used, for example, enamels, thermoplastics, silicone resins, or any other materials that are generally known and used by persons skilled in the art. Nevertheless, any non-toxic material used to form the outer shell 12 must be non-irritating and also biocompatible with the tissues and ph-balance in the mouth.

FIG. 2 is rear view of the dental appliance. As seen in FIG. 2, in the preferred embodiment, the outer shell 12 includes both an inner anterior wall 14 and an inner posterior wall 16 intended to be in mating engagement with an inner pliable layer 20. When the outer shell 12 is inserted in the patient's mouth, the bottom of the outer shell 18 prevents the patient's lower and upper front teeth from making contact thus preventing forcible teeth grinding or clenching.

As seen in FIG. 1, the invention further provides for an inner pliable layer 20 for mating engagement with the front upper incisors 40 and both the inner anterior wall 14 and the inner posterior wall 16 of the outer shell 12. In the preferred embodiment, the bite guard 10 is relatively small in size and is sized to fit the lower portion of the patient's front upper incisors 40 and may extend laterally, minimally beyond the front upper incisors 40 to the patient's front upper canines 46, 46′. In one embodiment, the inner pliable layer 20 is first placed into the outer shell 12, heated or warmed for example in warm (not boiling) water, making the inner pliable layer 20 malleable allowing it to be adapted and conforming to the shape of the outer shell 12 prior to being inserted into the patient's mouth. As the inner pliable layer 20 cools, it hardens and retains the shape of the patient's front upper incisors 40 and the outer shell 12 providing for a custom fit.

In an alternate embodiment, the inner pliable layer 20 may be inserted directly into the patient's mouth after it is heated and warmed in warm (not boiling) water. As the inner pliable layer 20 cools, it hardens and conforms to the shape of the patient's front upper incisors 40 providing for a custom fit. While the inner pliable layer 20 is still warm, the outer shell 12 may be added for mating engagement with the inner pliable layer 20, further securing the bite guard 10 in the patient's mouth. In both embodiments, the bite guard 10 is a secure custom fit that can be worn by the patient even for sleeping.

The inner pliable layer 20 may be formed from material such as polyvinyl siloxane, acrylic resin or other materials with similar or like properties. In the preferred embodiment, the inner pliable layer 20 comprises of a hydroplastic material. One of the advantages of using a hydroplastic material for the inner pliable layer 20 is that if the inner pliable layer 20 gets compromised or no longer fits securely it may be replaced or additional hydroplastic material may be added to perfect the fit.

FIG. 3 shows the outer shell 12 with the inner pliable layer 20 in mating engagement with the inner anterior wall 14 and the inner posterior wall 16 of the outer shell 12. The inner pliable layer 20 is disposed both anteriorly and posteriorly from the outer shell 12. In the preferred embodiment, the anterior portion 22 of the inner pliable layer 20 extends significantly beyond the posterior portion 24 as disposed in the outer shell 12. This allows for a more comfortable fit for the patient as the posterior portion 24 has to contend with the arch of the mouth as well as the proper placement of the tongue. In contrast, the anterior portion 22 of the inner pliable layer 20 has more available room prior to reaching the upper limits of the patient's lip. In an alternate embodiment, the inner pliable layer 20 is disposed equally from the inner anterior wall 14 and the inner posterior wall 16 of the outer shell 12. In either embodiment, the effectiveness of the bite guard 10 is not compromised but remains the same.

In some instances, for varied reasons a patient's dentition might undergo some periodic shifting which will affect the custom fit of the bite guard 10. Accordingly, additional hydroplastic material may be warmed and added to the bite guard 10 as shown in FIG. 3 to readapt and refit as necessary.

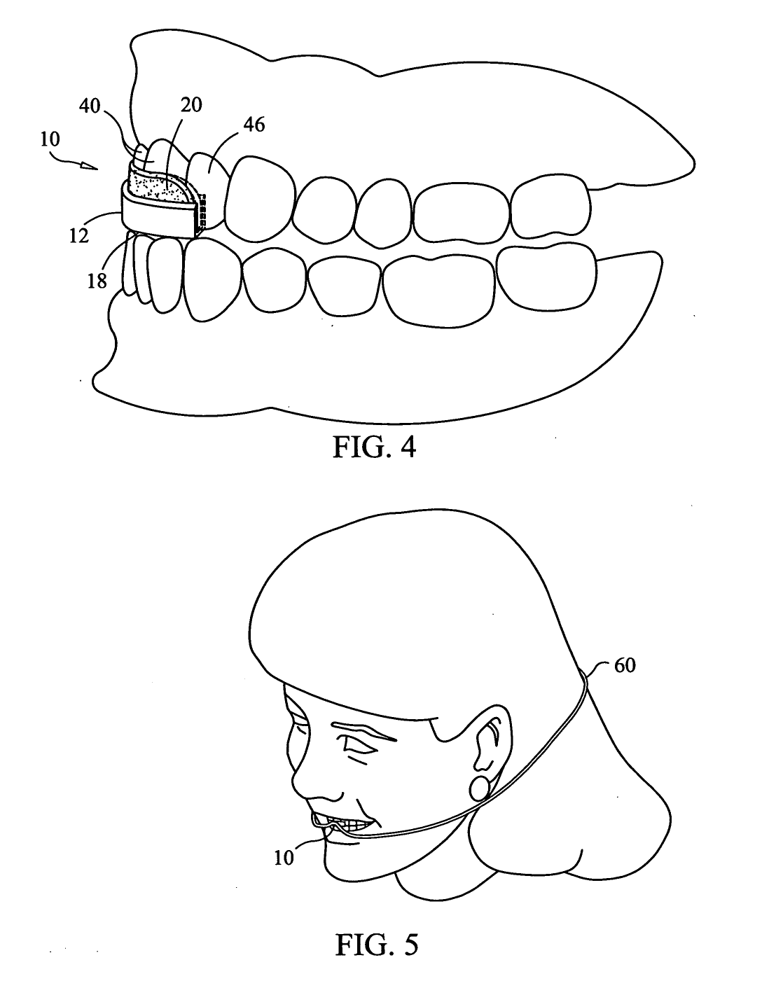

FIG. 4 shows the bite guard 10 in mating engagement with the lower portion of the patient's front upper incisors 40 and a portion of the upper canines 46, 46′ as secured by the inner pliable layer 20. The outer shell 12 is intended to be a seamless fit with the patient's dentition and extends minimally beyond the patient's front upper incisors 40 to the canines 46, 46′. Similarly, the outer shell 12 extends minimally above the bottom of the outer shell 18 to the lower portion of the patient's front upper incisors 40. The bite guard 10 is relatively small in configuration making it suitable for both children and adults yet effective enough to prevent the maxillary and mandibular teeth from contacting when the lower jaw is raised.

The inner pliable layer 20 makes both an anterior and posterior contact (not shown) over the patient's upper incisors 40. Once the outer shell 12 is fitted to the lower portion of the patient's upper incisors 40, the bite guard 10 prevents the upper mandible teeth and lower maxillary teeth from contacting each other thus preventing bruxism.

FIG. 5 shows an alternate embodiment wherein the bite guard 10 is further secured in the patient's mouth over the lower portion of the patient's front upper incisors 40 by means of leash 60 which is attached to the bite guard by other securing means, e.g. Velcro. In other embodiments the leash 60 may be permanently attached to the bite guard 10 with glue or any other means that will accomplish the purposes of the invention. The leash 60 further prevents the patient from accidentally swallowing the bite guard 10 when in use.

While an exemplary embodiment of the invention has been described in detail above, persons skilled in the art can appreciate that many modifications and/or improvements are possible without materially departing from the novelty and advantages of this invention. All such modifications and improvements are intended to be included within the scope of this invention as defined in the following claims.

What is claimed is:

1. A dental appliance comprising:
a firm outer shell with an anterior portion and a posterior portion having a radius of a curvature smaller than a dentition of a patient and sized to fit a lower portion of the patient's front incisors; and
a quantity of replaceable material in mating engagement with the outer shell wherein the replaceable material is adapted to conform to the shape of the patient's front incisors securing the dental appliance in the patient's mouth.

2. The dental appliance according to claim 1 including wherein the firm outer shell is made of a biocompatible material.

3. The dental appliance according to claim 1 including wherein the outer shell is made of a prefabricated polycarbonate matrix shell.

4. The dental appliance according to claim 1 including wherein the replaceable malleable material is made of a hydroplastic material.

5. A dental appliance comprising:
a firm outer shell with an anterior portion and a posterior portion having a radius of curvature smaller than a dentition of a patient and sized to fit a lower portion of the patient's front incisors;
an anterior surface of the firm outer shell with means for securing the dental appliance in the patient's mouth; and
a quantity of replaceable malleable material in mating engagement with the outer shell wherein the replaceable malleable material is adapted to conform to the shape of the patient's front incisors securing the dental appliance in the patient's mouth.

6. The dental appliance according to claim 5 including wherein the securing means includes a leash.

7. The dental appliance according to claim 5 including wherein the outer shell is made of a prefabricated polycarbonate matrix shell.

8. The dental appliance according to claim 5 including wherein the outer shell is made of a biocompatible material.

9. The dental appliance according to claim 5 including wherein the replaceable malleable material is made of a hydroplastic material.
